(19) United States
(12) Patent Application Publication
(10) Pub. No.: US 2009/0047498 A1
(43) Pub. Date: Feb. 19, 2009

(54) METHOD FOR PROVIDING NANOWEB COMPOSITE MATERIAL

(75) Inventors: Keith Ward Hutchenson, Lincoln University, PA (US); Matthew Arthur Page, Wilmington, DE (US); Anilkumar Raghavanpillai, Greenville, DE (US); Stefan Reinartz, Wilmington, DE (US); Cheryl Marie Stancik, Wilmingto, DE (US); Judith Johanna Van Gorp, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. duPont de Nemours and Company, Wilmington, DE (US)

(21) Appl. No.: 11/837,647

(22) Filed: Aug. 13, 2007

(51) Int. Cl. B32B 3/26; B05D 5/00

(52) U.S. Cl. 428/304.4; 427/243

(57) ABSTRACT

One aspect of the invention is a method for making a composite material comprising a porous support and a porous nanoweb comprising: (a) providing a porous support; (b) providing a gelling mixture comprising one or more solvent(s) and one or more organogelator(s); (c) applying the gelling mixture to the porous support; (d) inducing said organogelator(s) to form a nanoweb gel; and (e) removing the solvent(s) from the nanoweb gel to provide a dry porous nanoweb coating on said porous support; wherein the one or more solvent(s) is a supercritical fluid. Preferably the supercritical fluid is carbon dioxide. Other embodiments of the invention include a nanoweb composite provided by the method.

### FIELD OF INVENTION

The present invention relates to a method for preparing composite materials containing short perfluorinated alkyl chains useful as separation media. Furthermore the method is useful as a surface treatment method to provide oil- and water-repellency properties to substrates.

### BACKGROUND

The substantial removal of some or all of a particulate material from a fluid stream, e.g. gas or aqueous stream, can be important for many reasons including safety and health, machine operation and aesthetics. Filter media materials are used in filtration structures placed in the fluid path to obtain physical separation of the particulate from the fluid flow. Filter media are desirably mechanically stable, have good fluid permeability, relatively small pore size, low pressure drop and resistance to the effects of the fluid such that they can effectively remove the particulate from the fluid over a period of time without serious mechanical media failure. Filter media can be made from a number of materials in woven, non-woven or film material forms. Such materials can be air laid, wet laid, melt blown, or otherwise formed into a sheet-like material with an effective pore size, porosity, solidity or other filtration requirements.

Dense woven and nonwoven fabrics can operate as a combination of surface loading media and depth media, wherein the particles are trapped throughout the depth of the media. The pore size of the fabrics is dependent upon the size and density of the fibers and the process by which they are formed. The efficiency of the filter media is dependent upon many parameters including the depth of the filter media, pore size, and electrostatic nature of the material. However, it is often desirable to fine-tune the pore properties of depth media as exemplified in the following patents and patent applications.

Carlson, et al., in U.S. Pat. No. 4,629,652, disclose a process for providing a palletized aerogel comprising a support structure to a silicon-based pre-gel heated to supercritical conditions. Upon venting the fluid phase under supercritical conditions, the aerogel forms on and/or within the support structure. This method of solvent removal avoids the inherent shrinkage of the solid product that occurs when conventional drying techniques are employed. Martin, in U.S. Pat. No. 5,156,895, discloses a body including a support structure in which is formed monolithic aerogel. One aspect of the method of making the body includes a solvent substitution step and a supercritical drying step. In both of these cases, the aerogel is a covalently bonded cross-linked network.

Gels can be created in traditional organic solvents through non-covalent interactions such as hydrogen bonding, association between ionic groups, or association between electron-donating and electron-accepting moieties, of self-assembling, low molecular weight compounds. To form foams or materials from such gels, it is necessary to preserve the supramolecular aggregates created in solution, both during and after solvent removal. Although molecules that aggregate in solution are well known, for example via multipoint hydrogen bonding, only rarely do the aggregates form structures that can be preserved after removal of the solvent.

Weiss, et al., in U.S. Pat. No. 5,892,116, describes the gelation of various monomers with subsequent polymerization of the gelled monomers to form organic zeolites. The gelator is removed from the cross-linked matrix by treatment with a solubilizing solvent to provide a porous cross-linked matrix.

Woven and nonwoven fabrics are also used extensively in the protective apparel and building products markets. A key characteristic of barrier products is the ability to allow passage of air, while inhibiting the passage of particles, water and other liquids. WO 2004/027140 entitled “Extremely High Liquid Barrier Fabrics,” for instance, discloses many aspects of barrier fabrics.

In US 2004/0213918, Mikhael, et al., discloses a coating process that allows modification of the surface properties of a porous substrate without changing significantly the air permeability. This process is described as being accomplished by controlling the coating of individual fibers in ultra-thin layers that do not extend across the pores in the material.

Furthermore, various compositions are known to be useful as treating agents to provide surface effects to substrates. Surface effects include repellency to moisture, soil, and stains, and other effects, which are particularly useful for fibrous substrates and other substrates such as hard surfaces. Many such treating agents are fluorinated polymers or copolymers.

Most commercially available fluorinated polymers useful as treating agents for imparting repellency to substrates contain predominantly eight or more carbons in the perfluoroalkyl chain to provide the desired repellency properties. Honda et al, in Macromolecules, 2005, 38, 5699-5705 teach that for perfluoroalkyl chains of greater than 8 carbons, orientation of the R_{f} groups is maintained in a semi-crystalline configuration while for such chains having less than 6 carbon atoms, reorientation occurs. This reorientation decreases surface properties such as contact angle. Thus shorter chain perfluoroalkyls have traditionally not been successful commercially.

Various attempts have been made to improve particular surface effects and to increase the fluorine efficiency; i.e., boost the efficiency or performance of treating agents so that lesser amounts of the expensive fluorinated polymer are required to achieve the same level of performance or have better performance using the same level of fluorine. It is desirable to reduce the chain length of the perfluoroalkyl groups thereby reducing the amount of fluorine present, while still achieving the same or superior surface effects. Use of shorter chain perfluoroalkyl groups is one way to reduce the amount of fluorine present. Another approach is to provide alternative mechanisms for structure and ordering in the fluorinated materials having short flourinated tails. For instance, one approach is to combine the characteristics of structures known to undergo gelation via, for instance, hydrogen bonding, with short perfluorinated alkyl moieties. The ordering imposed upon the perfluorinated alkyl groups by the hydrogen bonding networks may amplify the ability of the perfluorinated alkyl moieties to order, thus increasing the fluorine efficiency of surface treating agents comprising such structures.

There is a need for methods to improve the repellency of treating agents for fibrous and/or porous substrates and hard surface substrates while using short chain perfluoroalkyl groups.

### SUMMARY OF INVENTION

One aspect of the invention is a method for making a composite material comprising a porous support and a porous nanoweb comprising:
(a) providing a porous support;
(b) providing a gelling mixture comprising one or more solvent(s) and one or more organogelator(s);
(c) applying the gelling mixture to the porous support;
(d) inducing said organogelator(s) to form a nanoweb gel; and
(e) removing the solvent(s) from the nanoweb gel to provide a dry porous nanoweb coating on said porous support;
   wherein the one or more solvent(s) is a supercritical fluid. In a preferred embodiment the supercritical fluid is supercritical carbon dioxide (scCO₂).

Another aspect of the invention is a nanoweb composite provided by the method of the invention.

### DESCRIPTION OF FIGURES

FIG. 1 is a scanning electron micrograph at 2000× magnification of composite 1B according to an embodiment of the present invention.

### DETAILED DESCRIPTION

Hereinafter trademarks are designated by upper case.

The applicants have found that conventional porous supports used as filter media and other barrier fabrics can be modified by coating of a gelling mixture containing an organogelator and a supercritical fluid, onto, and optionally infusion into a porous support, followed by gelling the organogelator to form a nanoweb gel. Removal of the supercritical fluid can give a dry porous nanoweb coating that may interpenetrate the original porous support. The applicants have found that a variety of gelling materials and porous supports can give useful nanoweb composite materials using the methods disclosed herein. The method provides coatings that are characterized by fibrous structures that generally overlay and bridge individual fibers and pores of porous supports. Applicants have found the coated products can have very high water contact angles and high hydrocarbon repellency relative to that of uncoated porous supports.

In another embodiment, a porous interpenetrating nanoweb is provided by the non-covalent bonding in a supramolecular assembly of molecules providing a composite material with useful properties.

In another embodiment, the nanowebs not only coat, but also interpenetrate the porous support to form three dimensional nanowebs on and within the porous support.

In another embodiment, depending on the pore sizes in the support, the inventive nanowebs do not bridge the pores, but instead act to coat the support fibers themselves.

In a preferred embodiment, the method uses as a solvent, scCO₂ in providing the composite material.

Useful porous supports include woven and nonwoven fabrics, sheet materials and films, monolithic aggregates, powders, and porous articles such as frits and cartridges. Porous supports include: woven fabrics comprising glass, polyamides including but not limited to polyamide-6,6 (PA-66), polyamide-6 (PA-6), and polyamide-6,10 (PA-610), polyesters including but not limited to polyethylene terephthalate (PET), polytrimethylene terephthalate, and polybutylene terephthalate (PBT), rayon, cotton, wool, silk and combinations thereof; nonwoven materials having fibers of glass, paper, cellulose acetate and nitrate, polyamides, polyesters, polyolefins including bonded polyethylene (PE) and polypropylene (PP), and combinations thereof. Porous supports include nonwovens fabrics, for instance, polyolefins including PE and PP such as TYVEK® nonwoven fabric (flash spun PE fiber), SONTARA® nonwoven fabric (nonwoven polyester), and XAVAN® nonwoven fabric (nonwoven PP), SUPREL® nonwoven composite sheet, a nonwoven spunbond-meltblown-spunbond (SMS) composite sheet comprising multiple layers of sheath-core bicomponent melt spun fibers and side-by-side bicomponent meltblown fibers, such as described in U.S. Pat. No. 6,548,431, U.S. Pat. No. 6,797,655 and U.S. Pat. No. 6,831,025, herein incorporated by reference all trademarked products of E.I. du Pont de Nemours and Company; nonwoven composite sheet comprising sheath-core bicomponent melt spun fibers, such as described in U.S. Pat. No. 5,885,909, herein incorporated by reference; other multi-layer SMS nonwovens that are known in the art, such as PP spunbond-PP meltblown-PP spunbond laminates; nonwoven glass fiber media that are well known in the art and as described in Waggoner, U.S. Pat. No. 3,338,825, Bodendorf, U.S. Pat. No. 3,253,978, and references cited therein, hereby incorporated by reference; and KOLON® fabric, a spunbond polyester trademarked product of Korea Vilene. The nonwovens materials include those formed by web forming processing including dry laid (carded or air laid), wet laid, spunbonded and melt blown. The nonwoven web can be bonded with a resin, thermally bonded, solvent bonded, needle punched, spun-laced, or stitch-bonded. The bicomponent melt spun fibers, referred to above, can have a sheath of PE and a core of polyester. If a composite sheet comprising multiple layers is used, the bicomponent melt-blown fibers can have a PE component and a polyester component and be arranged side-by-side along the length thereof. Typically, the side-by-side and the sheath/core bicomponent fibers are separate layers in the multiple layer arrangement.

Preferred nonwoven porous supports include woven fabrics comprising glass, polyamides, polyesters, and combinations thereof; and nonwoven fabrics comprising glass, paper, cellulose acetate and nitrate, polyamides, polyesters, polyolefins, and combinations thereof. Most preferred porous supports include nonwoven bonded PE, PP, and polyester, and combinations thereof.

Other preferred nonwoven porous supports include electrospun nanofiber supports such as described by Schaefer, et al., in US 2004/0038014, hereby incorporated by reference; and electro-blown nanofiber supports disclosed in Kim, WO 2003/080905, hereby incorporated by reference. The nanofiber supports can be self-supporting or can be supported by other porous support layers. Preferably, the electropsun fiber supports are nanofiber supports comprised of nanofibers with an effective fiber diameter in the range of about 20 nm to about 1 μm, and preferably about 100 nm to about 750 nm. Suitable nanofiber supports include those derived from electro-spinning of polyester, polyamide, cellulose acetate, polyvinylidene fluoride (PVdF), polyacrylonitrile (PAN), polysulfone, polystyrene (PS), and polyvinyl alcohol (PVA). A preferred nanofiber porous support is incorporated into a layered structure comprising one or more other porous supports or scrims, for instance, nonwoven bonded PE or PP, and one or more layers of nanofiber, such as described in U.S. patent application Ser. No. 10/983,513 filed in November 2004, hereby incorporated by reference.

Other porous supports include microporous polymer films and sheet materials such as polyethersulfone, hydrophilic polyethersulfone, polyamide, PP, polytetrafluoroethylene (PTFE), and cellulose esters including cellulose acetate and nitrate. Microporous polymer films include stretched PTFE materials such as those manufactured by W.L. Gore and Associates, Inc. under the trade name GORE-TEX® membranes, and TETRATEX® PTFE membrane film, manufactured by the Donaldson Company; PP membranes; hydrophilic PP membranes, nitrocellulose membranes such as BIOTRACE™ NT membranes, modified nylon membranes such as BIO-INERT® membranes, PVdF membranes such as BIOTRACE™ PVDF membranes, polyethersulfone membranes such as OMEGA™ membranes, SUPOR® hydrophilic polyethersulfone membrane, ion exchange membranes such as MUSTANG™ ion exchange membranes, all brand names of Pall Life Sciences; nylon membranes disclosed in U.S. Pat. No. 6,413,070 and references cited therein, herein incorporated by reference. Preferred microporous polymer films are polyethersulfone, hydrophilic polyethersulfone, polyamide, PP, PTFE, and cellulose esters.

Further porous supports include inorganic materials comprising clay, graphite, talc, glass, sintered metals and ceramics; and wood and wood laminates. The above list of porous supports while extensive is not meant to be exhaustive; other supports may be likewise used in the structures detailed in the examples as one skilled in the art may readily accomplish.

Preferred H-bonded organogelators include those of formulae (I) and (II), including isomers and mixtures of isomers thereof:

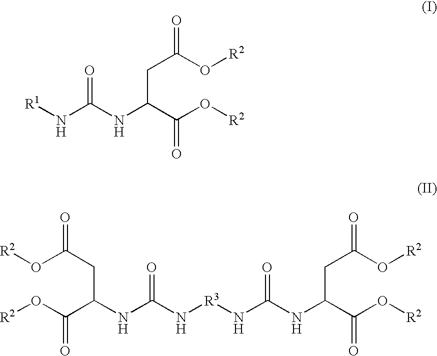

wherein
R¹ is a monovalent radical selected from C₁ to C₁₆ linear or branched alkyl group, optionally substituted with one or two carbon-carbon double bonds and optionally interrupted by one or two —OC(O)— groups; C₁ to C₆ linear or branched alkyl group bearing a C₅-C₁₆ cycloaliphatic group, optionally substituted with one or two carbon-carbon double bonds and optionally interrupted by one or two —OC(O)— groups; C₅-C₁₆ cycloaliphatic or alkyl substituted cycloaliphatic group optionally substituted with one or two carbon-carbon double bonds and optionally interrupted by one or two —OC(O)— groups; C6 to C16 aromatic or alkyl substituted aromatic group optionally substituted with one or two substituents selected from Cl, Br, I, F, CF₃, and CF₃O; C1 to C6 alkyl bearing a C6 to C16 aromatic or alkyl substituted aromatic group optionally substituted with one or two substituents selected from Cl, Br, I, F, CF₃, and CF₃O; R² is —(CH₂)ᵤ—R_{f};
u is an integer of 1 to 4;
R_{f} is a linear or branched partially or fully fluorinated alkyl having 5 to about 20 carbon atoms, and most preferably 6 carbon atoms, optionally interrupted by one to 6 oxygen atoms, wherein the ratio of oxygen atoms to carbon atoms is about 1:2 to about 1:10; each carbon atom having at most one oxygen atom bonded to it, and covalent bonding between oxygen atoms is absent;
R³ is a divalent radical selected from C3 to C18 linear or branched alkylene, optionally, interrupted by one or two —OC(O)—; C1 to C6 linear or branched alkylene bearing a C5-C16 cycloaliphatic radical; C5-C16 cycloaliphatic or alkyl substituted cycloaliphatic radical; C6 to C16 aromatic or alkyl substituted aromatic radical optionally substituted with a group selected from Cl, Br, I, F, CF₃, and CF₃O; C1 to C6 alkyl bearing an C6 to C16 aromatic or alkyl substituted aromatic radical, optionally substituted with a group selected from Cl, Br, I, F, CF₃, and CF₃O; and
—(CH₂CH₂O)ₘ(CH₂CH₂)—, wherein m is an integer of 1 to 4.

Compounds of formulae (I) and (II) are available by synthesis according to the procedures disclosed in WO 00/35998.

Other H-bonded organogelators include those of formula (III)

Rₒ-[L-(C_{q}H_{2q}S)ₚCᵣH₂ᵣR_{f}¹]₂ (III)

wherein

Rₒ is a divalent organic group having 2 to 40 carbon atoms;

L is a linking group selected from —NHC(O)NH— or —C(O)NH— wherein the left side of the linking group is bonded to Rₒ;

p is an integer of 0 or 1;

q is an integer of 2 to 10;

r is an integer of 1 to 10; and

R_{f}¹ is a linear or branched C₁-C₆ perfluoroalkyl group.

Preferably Rₒ is selected from: C₂-C₁₈ linear or branched alkyl group; C₂-C₁₈ linear or branched alkyl group substituted, or interrupted by, a C₄-C₁₆ cycloaliphatic group; C₂-C₁₈ linear or branched alkyl group substituted, or interrupted by, a C₄-C₁₆ aromatic group; C₂-C₁₈ linear or branched alkyl groups substituted, or interrupted by, a C₄-C₁₆ cycloaliphatic group and a C₄-C₁₆ aromatic group; C₄-C₁₆ cycloaliphatic group; C₄-C₁₆ aromatic group; and C₄-C₁₆ cycloaliphatic group having a C₄-C₁₆ aromatic group; wherein each aromatic group is optionally substituted with one or more Cl or Br; each alkyl and cycloaliphatic group is optionally substituted with one or two carbon-carbon double bonds; each group is optionally interrupted by one to two heteroatoms selected from the group: —O—, —S— and —NR⁴—; and each group is optionally interrupted by one to four linkers selected from the group —S—, —N═, —OC(O)—, —C(O)NR⁴—, —OC(O)NR⁴—, —NR⁴C(O) NR⁴—; wherein R⁴ is selected from: hydrogen and C₁-C₄ alkyl group.

Useful in some embodiments are compounds of formula (III) wherein L is —NHC(O)NH—, corresponding to a class of bis-ureas of formula (IV):

R_{f}CᵣH₂ᵣ(SC_{q}H_{2q})ₚNHC(O)NH—Rₒ—NHC(O)NH—(C_{q}H_{2q}S)ₚCᵣH₂ᵣR_{f} (IV)

wherein p, q, r, Rₒ, and R_{f} are as defined above. Compositions of formula (IV) can be provided by condensation of diisocyanates with two equivalents of primary perfluoroalkyl alkyl amines. Typically a tertiary amine, for instance triethylamine, is used as catalyst, but other catalysts, or no catalyst, can be used if so desired. Typically a nonhydroxylic hydrocarbon solvent such as toluene or xylenes or a halocarbon such as dichloromethane (DCM) is used in the condensation.

Diisocyanates useful in the synthesis of bis-ureas of formula (IV) include 2,4 and 2,6-toluene diisocyanate, 4,4′-diphenylmethane diisocyanate (MDI), 1,3- and 1,4-phenylene diisocyanate, m- and/or p-xylylene diisocyanate (XDI), hexamethylene diisocyanate, tetramethylene diisocyanate, dodecamethylene diisocyanate, methyl pentamethylene diisocyanate, 2,2,4-trimethylhexamethylene diisocyanate, lysine diisocyanate, isophorone diisocyanate (IPDI), 1,3- and 1,4-diisocyanatocyclohexane, methyl cyclohexylene diisocyanate (hydrogenated TDI), dicyclohexylmethane-4,4′-diisocyanate (hydrogenated MDI). They are available from Bayer Inc., Pittsburgh, Pa., and Aldrich Chemical Co., Milwaukee Wis. Preferred are hexamethylene diisocyanate, methyl cyclohexylene diisocyanate, lysine diisocyanate, and isophorone diisocyanate. Most preferred is hexamethylene diisocyanate.

Useful in some embodiments are compounds of formula (III) wherein L is —C(O)NH—, corresponding to a class of bis-amides of formula (V):

R_{f}CᵣH₂ᵣ(SC_{q}H_{2q})ₚNHC(O)—Rₒ—C(O)NH—(C_{q}H_{2q}S)ₚCᵣH₂ᵣR_{f} (V)

wherein p, q, r, Rₒ, and R_{f} are as defined above. Compositions of formula (V) can be provided by condensation of diacid chlorides with two equivalents of primary perfluoroalkyl alkyl amines. The condensation is typically performed in the presence of a tertiary amine, for instance triethylamine, or other base. Typically a nonhydroxylic hydrocarbon solvent such as toluene or xylenes or a halocarbon such as dichloromethane (DCM) is used in the condensation.

Dicarboxylic acid chlorides useful in the synthesis of compositions of formula (III) include cyclohexane-1,4-dicarboxyl dichloride, succinoyl dichloride, adipoyl dichloride, suberoyl chloride, phthaloyl chloride, isophthaloyl chloride, and terephthaloyl chloride, all available from Aldrich Chemical Co or by synthesis. A preferred diacid chloride is suberoyl chloride.

The primary perfluoroalkyl alkyl amines useful in formation of compounds of formula (III) are available by synthesis using well-known synthetic methods. For instance, 1H,1H,2H,2H-perfluoroalkyl amines are synthesized from corresponding iodides via treatment with sodium azide followed by reduction using Raney Ni as described in the literature procedure (Trabelsi, H.; Szoenyi, F.; Michelangeli, N.; Cambon, A. J. Fluorine. Chem., 1994, 69, 115-117). The 2-(1H,1H,2H,2H-perfluoroalkylthio)ethylamines can be prepared by the reaction of 1H,1H,2H,2H-perfluoroalkyl iodides with 2-aminoethanethiol as described in Rondestvedt, C. S., Jr.; et al, J. Org. Chem. 1977, 42, 2680. In a similar manner, reaction of 1H,1H,2H,2H-perfluoroalkyl iodides with 3-aminopropanethiol or 4-aminobutanethiol provides the corresponding 3-(1H,1H,2H,2H-perfluoroalkylthio)propylamines and 4-(1H,1H,2H,2H-perfluoroalkylthio)butylamines, respectively. Higher homologs of the ω-aminoalkylthiols can be treated in a similar manner.

An organogelator is defined herein to include a non-polymeric organic compound whose molecules can establish, between themselves, at least one physical interaction leading to a self-assembly of the molecules in a carrier fluid, with formation of a 3-D network, or a “nanoweb gel”, that is responsible for gelation of the carrier fluid. The nanoweb gel may result from the formation of a network of fibrous structures due to the stacking or aggregation of organogelator molecules. Depending on the nature of the organogelator, the fibrous structures have variable dimensions that may range up to one micron, or even several microns. These fibrous structures include fibers, strands and/or tapes.

The term “gelling” or “gelation” means a thickening of the medium that may result in a gelatinous consistency and even in a solid, rigid consistency that does not flow under its own weight. The ability to form this network of fibrous structures, and thus the gelation, depends on the nature (or chemical structure) of the organogelator, the nature of the substituents, the nature of the carrier fluid, and the particular temperature, pressure, concentration, pH, shear conditions and other parameters that may be used to induce gelation of the medium. The nanoweb gels can be reversible. For instance, gels formed in a cooling cycle may be dissipated in a heating cycle. This cycle of gel formation can be repeated a number of times since the gel is formed by physical, non-covalent interactions between gelator molecules, such as hydrogen bonding.

The nanoweb gel includes a nanoweb phase and a fluid phase, which, upon removal of the fluid, forms a porous interpenetrating nanoweb. The applicants have found that this capability is strongly dependent upon the particular structural characteristics of the organogelator and particular processing parameters including the nature of the solvent, temperature, gelator concentration, method of solvent removal, and the nature of the porous support.

A preferred solvent for use in the methods disclosed herein is a supercritical fluid. A fluid is in the supercritical fluid state when a system temperature and pressure exceed the corresponding critical point values defined by the critical temperature (T_{C}) and pressure (P_{C}). For pure substances, the critical temperature and pressure are the highest at which vapor and liquid phases can coexist. Above the critical temperature, a liquid does not form for a pure substance, regardless of the applied pressure. Similarly, the critical pressure and critical molar volume are defined at this critical temperature corresponding to the state at which the vapor and liquid phases merge. Similarly, although more complex for multicomponent mixtures, the mixture critical state is identified as the condition at which the properties of coexisting vapor and liquid phases become indistinguishable. For a discussion of supercritical fluids, see Kirk-Othmer Encycl. of Chem. Technology, 4^{th} Ed., Vol. 23, pg. 452-477.

A preferred supercritical fluid is carbon dioxide (scCO₂). Advantages of scCO₂ include that it is environmentally friendly relative to typical organic solvents; and can be readily removed after gel formation by slow venting of the carbon dioxide. In addition, scCO₂ is an attractive medium for preparing composites from organogelators because the solvent and transport properties of the supercritical fluid solution (e.g., the solution density) can be varied appreciably and continuously with relatively minor changes in temperature or pressure. Thus, the solvent environment can be optimized for a specific gelation application by tuning the various density-dependent fluid properties. The gelling mixture, as applied to a solid or porous support, can be in the form of a homogeneous isotropic solution, a nonhomogeneous solution comprising an organogelator phase and fluid-solubilized organogelator, or a gel that can be shear-thinned (thixotropic) to form a fluidized gel. Formulation of a suitable gelling mixture depends upon the methods anticipated for applying the gelling mixture and gelling the impregnated or coated support.

In another preferred embodiment the gelling mixture is a homogeneous isotropic solution that, if so desired, is heated above ambient conditions. Typically when using a supercritical fluid, applying the gelling mixture to a solid or porous support can be done, by immersing the support in the gelling mixture. After immersing the support in the gelling mixture, the treated support can be cooled to induce gelation. Suitable gelling mixtures preferably comprise 0.01 to 20 wt % of one or more organogelators, and preferably, 0.5 to 5 wt %, with the remainder being solvent, e.g. supercritical fluid.

Drying the gel, or removing the solvent from the gel, will leave behind a porous nanoweb on and/or within a solid or porous support. In a preferred process, removing the solvent(s) from the nanoweb gel comprises critical point drying and/or supercritical fluid extraction. When scCO₂ is used as the solvent, it can be removed from the gel by slowly venting off the CO₂.

For fibrous substrates, the amount of composition of formula (I) applied, in order to obtain a nanoweb composite material, is about 0.1 to about 2.0 wt %, and preferably about 0.1 to about 1.0 wt %, based on the dry wt of substrate. For fibrous substrates, the treated substrate preferably contains about 100 micrograms per gram to about 10,000 micrograms per gram fluorine, and more preferably about 100 micrograms per gram to about 1,000 micrograms per gram fluorine, based on the weight of the dried substrate; to provide significant surface treatment properties such as increases in water and oil contact angles.

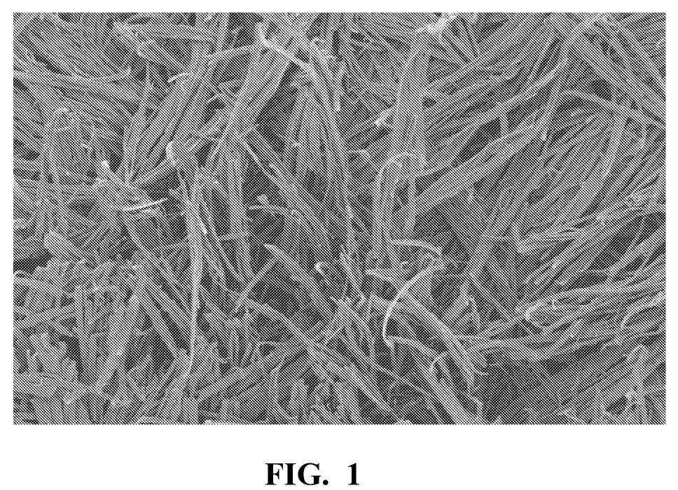

The nanoweb composites can be characterized by scanning electron microscopy. FIG. 1 is the scanning electron micrograph (SEM) of a composite according to one embodiment, at 2000× magnification, showing the nanoweb features characteristically provided by the method.

The methods disclosed herein provide composites that can be characterized by a quantitative estimation of the surface tension relative to that of the support. Surface tension is typically characterized by measuring the contact angle of a water droplet or other liquid substance, contacting the surface in the advancing and receding dynamic modes. An advancing contact angle is measured as a liquid droplet is increasing in size and advancing on the surface of a substrate. A receding contact angle is measured as a liquid droplet is decreasing in size and receding on the surface of a substrate. Contact angles can also be measured in a static mode. This is a well known method for determining surface properties and is disclosed, for example, in Physical Chemistry of Surfaces, 4th Ed., Arthur W. Adamson, John Wiley & Sons, 1982, pp. 338-361. The water contact angle is a quantitative measurement of the hydrophobicity of a surface. The higher the hydrophobicity of the substrate, the higher the contact angle of the water droplet contacting the substrate. Surfaces exhibiting water droplet advancing contact angles of greater than 150° are considered super-hydrophobic. The details of contact angle measurements are discussed in the examples. Some referred nanoweb composites have a water droplet advancing contact angle of greater than 130°. Some preferred composites have a hexadecane droplet advancing contact angle of greater than 60°, indicating oleophobicity.

The composite materials of various embodiments of the invention can be used, for example, as gas-solid filter. The gas can be air, carbon dioxide, oxygen, nitrogen, a noble gas, or any other process gas used in industrial or commercial processes. Air filters are preferred applications of the composite materials. Filters can be in the form of nonwoven pleated or unpleated cartridge filters, glass or other ceramic microfiber filters.

There are conditions in which the porous nanoweb can be easily dissolved and removed from the porous support. In applications wherein trapped material is of significant interest, for example, biological material, radioactive material, etc., the solubility of the nanoweb is a particular advantage, as it can allow release and recovery of the trapped material. Such flexibility can be useful in recycling and recovery of composite materials as well.

The composite materials of various embodiments can be used, for example, in barrier fabric applications, such as for protective clothing or construction wrap, in which a barrier against liquid penetration is provided while maintaining air and moisture vapor permeability.

These examples are illustrative and are not to be read as limiting the scope of the invention as it is defined by the appended claims.

### Materials and Methods

The following abbreviations are used in the examples:

DMF=dimethylformamide

DMSO=Dimethyl sulfoxide

mp=melting point

MPa=mega-Pascal (10⁶ Pascals, 1 bar=0.100 MPa)

RT=room temperature

TEA=triethyl amine

TFA=trifluoroacetic acid

THF=tetrahydrofuran

All solvents and reagents, unless otherwise indicated, were purchased from Commercial Sources and used directly as supplied. 1H,1H,2H,2H-perfluorohexylamine was synthesized from corresponding iodides via the azide followed by reduction using Raney Ni as described in the literature procedure (Trabelsi, H.; Szoenyi, F.; Michelangeli, N.; Cambon, A. J. Fluorine. Chem., 1994, 69, 115-117). 2-(1H,1H,2H,2H-perfluorohexylthio)ethylamine was prepared by the reaction of 1H,1H,2H,2H-perfluoralkyl iodides with 2-aminoethanethiol as disclosed in the literature procedure (Rondestvedt, C. S., Jr.; Thayer, G. L., Jr. J. Org. Chem. 1977, 42, 2680). ¹H and ¹⁹F NMR spectra were recorded on a Brucker DRX 400 or 500 Spectrometer. Chemical shifts have been reported in ppm relative to an internal reference (CDCl₃, CFCl₃ or TMS). All melting points reported were uncorrected.

Method 1. Gel-Impregnation on Nonwoven Supports in scCO₂

Nonwoven fabrics: TYVEK® polyethylene nonwoven fabric (E.I. du Pont de Nemours, Wilmington Del.); and KOLON® 70 gsm spunbound polyester fabric (Korea Vilene Inc) were mounted in a high-pressure variable volume view cell equipped with a TEFLON® polymer-coated stir bar and an electrical heating jacket. A gelator was charged to the cell and the cell was sealed and then charged with liquid CO₂ to give a final gelator concentration of 0.3-0.7 wt %. The cell was then heated to about 70 to 100° C. and pressurized to 208-350 bar (20.8-35 MPa) with agitation to solubilize a significant portion of the gelator. Agitation was then suspended and the cell was slowly cooled to room temperature over several hours at constant pressure to allow gel formation within the cell volume and within and upon the nonwoven fabric samples. The CO₂ was then slowly vented from the view cell, and the gelled sample was removed from the cell and imaged by scanning electron microscopy, revealing a gelled nanoweb microstructure.

Compound 1 was prepared according to the following method. Boc-Asp-OH (4.0 g, 17.22 mmol) was esterified using 2 equivalents of 1H,1H,2H,2H-perfluorohexanol (9.11 g, 34.5 mmol) to obtain the 1H,1H,2H,2H-perfluorohexyl diaspartate as a white crystalline solid (10.5 g). The diaspartate (10.3 g, 14.2 mmol) was deprotected using TFA to obtain the amino ester as a viscous oil (7.64 g). The amino ester (2.5 g, 4.0 mmol) was treated with 1,4-dicyanatohexane (0.336 g, 2.0 mmol) in methylene chloride to obtain compound 1 as a white crystalline solid (2.2 g): ¹H NMR (DMSO-d6, 100° C.): δ 6.10 (d, J=8.5 Hz, 2H), 5.96 (t, 1H, J=5.5 Hz, 2H), 4.59 (m, 2H), 4.36 (m, 8H), 3.35 (q, J=6.5 Hz, 4H), 2.73 (m, 4H) 2.65 (m, 8H),1.39-1.27 (m, 8H); ¹⁹F NMR (DMSO-d6, 100° C.): δ −80.8 (m, 12F) −112.5 (m, 8F), −124.0 (s, 8F), −125.4 (m, 8F).

Compound 1 was prepared according to the following method.

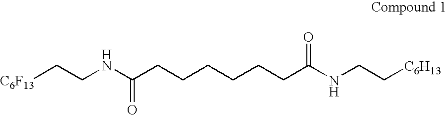

To a mixture of 1H,1H,2H,2H-perfluorooctylamine (3.6 g, 9.9 mmol), DCM (30 mL) and TEA (0.999 g, 9.9 mmol) under a N₂ purge was added suberoyl chloride (0.949 g, 4.5 mmol) and the mixture stirred for 12 h at RT. The reaction mixture was concentrated to half its volume and filtered. The solid product was washed with cold DCM (5 mL) followed by 1% HCl (2×5 mL), water (2×5 mL) and finally with hexanes (2×5 mL). The resulting solid was recrystallized from methanol to provide Compound 1: mp 114.1-115.2° C.; ¹H NMR (methanol-d4): δ 3.48 (t, J=6.8 Hz, 4H), 2.39 (m, 4H), 2.18 (t, J=7.6 Hz, 4H), 1.59 (m, 4H), 1.34 (m, 4H); ¹⁹F NMR (methanol-d4): δ −84.3 (m, 6F), −117.1 (m, 4F), −124.6 (m, 4F), −125.9 (m, 4F), −126.6 (m, 4F), −128.9 (m, 4F).

Compound 2 was prepared according to the following method.

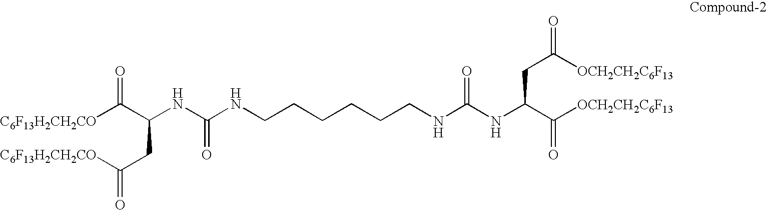

Boc-Asp-OH (18.0 g, 77.49 mmol) was esterified using 2 equivalents of 1H,1H,2H,2H-perfluorooctanol (56.4 g, 155.1 mmol) to obtain 1H,1H,2H,2H-perfluorooctyl diaspartate as a solid (60.9 g). The diaspartate (62 g, 67.0 mmol) was deprotected using TFA to obtain the amino ester as a low melting solid (52 g). The amino ester (2.5 g, 3.03 mmol) was treated with 1,4-dicyanatohexane (0.252 g, 1.50 mmol) to obtain compound 2 as a solid (2.68 g): ¹H NMR (DMSO-d6, 100° C.): δ 6.10 (d, J=8.0 Hz, 2H), 5.96 (t, J=5.5 Hz, 2H), 4.58 (m, 2 H), 4.36 (m, 8H), 3.30 (q, J=6.5 Hz, 4H), 2.74 (m, 4H) 2.63 (m, 8H),1.39-1.27 (m, 8H); ¹⁹F NMR (DMSO-d6, 100° C.): δ −80.6 (m, 6F) −112.3 (m, 4F), −121.4 (m, 4F), −122.4 (s, 4F), −123.0 (s, 4F),−125.5 (m, 4F).

Compound 3 was prepared according to the following method.

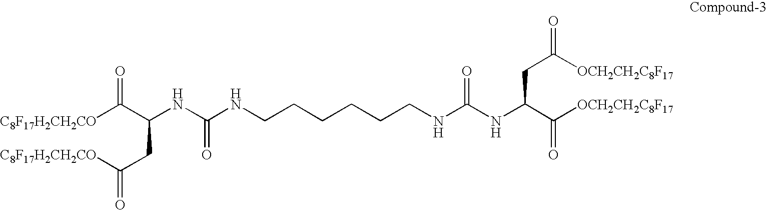

Boc-Asp-OH (6.3 g, 27.0 mmol) was esterified using 2 equivalents of 1H,1H,2H,2H-perfluorononanol (25.0 g, 54.0 mmol) to obtain 1H,1H,2H,2H-perfluorooctyl diaspartate as a solid (29.2 g). The diaspartate (29.2 g, 26.0 mmol) was deprotected using trifluoroacetic acid to obtain the TFA salt of amino ester as a solid (20.8 g). The amino ester (5.0 g, 4.4 mmol) was treated with 1,4-dicyanatohexane (0.37 g, 2.2 mmol) and TEA (0.444 g, 4.4 mmol) to provide compound 3 as a solid (3.8 g): ¹H NMR (TFA) 5.05 (t, J=5.5 Hz, 2H), 4.69 (m, 2H), 4.55 (m, 8H), 3.35 (q, J=6.8 Hz, 4H), 3.12 (m, 4H) 2.60 (m, 8H),1.61 (m, 4H), 1.40 (m, 4H).

Compound 4 was prepared according to the following method.

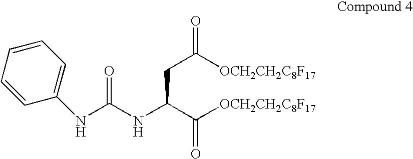

Using a similar procedure as described for the synthesis of compound 3, the aminoester (7.8 g, 0.0068 mol) was treated with TEA (1.11 mL, 0.008 mol,) and phenyl isocyanate to provide compound 4 as a solid (7.5 g). ¹H NMR (THF-d8): δ 8.0 (t, J=6.0 Hz, 1H), 7.64 (dd, J=8.0, 1.2 Hz, 2H), 7.24 (tm, J=8.0 Hz, 2H), 7.0 (tm, J=8.4 Hz, 1H), 6.0 (d, J=8.0 Hz, 1H). 4.67 (m, 1H), 4.3 (m, 4H), 2.98-2.73 (m, 2H), 2.50 (m, 4H).

### EXAMPLE 1A and 1B

This example illustrates the gel impregnation of compound 1 in TYVEK® nonwoven polyethylene fabric and KOLON® 70 gsm spunbound polyester nonwoven fabric using Method 1—Gel-impregnation on Nonwoven Supports in scCO₂.

A weighed sample of TYVEK® polyethylene nonwoven fabric was gel impregnated with Compound 1 at an overall gelator concentration of 0.33 wt %, temperature of 71° C., and cell pressure of 208 bar (20.8 MPa) to provide a composite material 1A.

Another composite material was prepared with KOLON® 70 gsm spunbound polyester fabric and Compound 1 to provide composite material 1B.

The contact angles of the composite materials were measured, and the results are summarized in Table 1. A scanning electron micrograph at 2000× magnification of composite 1B was obtained, displayed in FIG. 1, and exhibited the nanoweb structure of the composite of the invention provided by gelation in scCO₂. The typical width of the fibers is about 0.1 to about 0.36 microns.

### EXAMPLE 2

This example illustrates the gel impregnation of compound 2 in KOLON® 70 gsm spunbound polyester in scCO₂.

Following the procedure as described in example 1, a weighed sample of KOLON® polyethylene nonwoven fabric (2.8 cm×4.6 cm) was gel impregnated with compound 2 at an overall gelator concentration of 0.21 wt %, temperature of 68° C., and cell pressure of 242 bar (24.2 MPa) to provide a composite material 2A.

### EXAMPLE 3

This example illustrates the composite material created by the impregnation of compound 3 in TYVEK® polyethylene nonwoven fabric and in KOLON® 70 gsm spunbound polyester in scCO₂. Following the procedure as described in example 1, a weighed sample of TYVEK® polyethylene nonwoven fabric (2 cm×2 cm) was gel impregnated with compound 3 at an overall gelator concentration of 0.56 wt %, temperature of 72° C., and cell pressure of 346 bar (34.6 MPa) to provide a composite material 3A.

Using KOLON® 70 gsm spunbound polyester fabric (2 cm×2 cm) and compound 3, provided a composite material 3B.

### EXAMPLE 4

This example illustrates the composite material created by the impregnation of compound 4 in TYVEK® polyethylene nonwoven fabric and SONTARA® nonwoven polyester fabric in scCO₂.

Following the procedure as described in example 1, a weighed sample of TYVEK® polyethylene nonwoven fabric (2 cm×2 cm) was gel impregnated with compound 4 at an overall gelator concentration of 3.6 wt %, temperature of 71° C., and cell pressure of 304 bar (30.4 MPa) to provide a composite material 4A.

Using SONTARA® nonwoven polyester fabric (2 cm×2 cm) and compound 4, provided a composite material 4B.

Scanning electron micrographs of composites 4A and 4B similar to that of FIG. 1 were obtained, and exhibited the nanoweb structure of the composite of the invention provided by gelation in scCO₂.

### EXAMPLE 5

### Contact Angle Measurements

This example illustrates the contact angles of the composite materials 1A, 1B, 2A, 3A and 3B.

Contact angle (CA) measurements to determine the contact angle of both water and hexadecane on a surface were performed using a Ramé-Hart Standard Automated Goniometer Model 200 employing DROP image standard software and equipped with an automated dispensing system with a 250 μl syringe and an illuminated specimen stage assembly; according to procedures in the Manufacturer's manual. The goniometer camera was connected through an interface to a computer that allowed the droplet to be visualized on a computer screen. The horizontal axis line and the cross line could both be independently adjusted on the computer screen using the software.

Prior to contact angle measurement, the sample was placed on the sample stage and the vertical vernier adjusted to align the horizontal line (axis) of the eye piece coincident to the horizontal plane of the sample, and the horizontal position of the stage relative to the eye piece positioned so as to view one side of the test fluid droplet interface region at the sample interface.

To determine the contact angle of the test fluid on the sample, approximately one drop of test fluid was dispensed onto the sample using a 30 μL pipette tip and an automated dispensing system to displace a calibrated amount of the test fluid. For water measurements deionized water was employed, and for oil measurements, hexadecane was suitably employed. Horizontal and cross lines were adjusted via the software in case of the Model 200 after leveling the sample via stage adjustment, and the computer calculated the contact angle based upon modeling the drop appearance. The initial contact angle is that angle determined immediately after dispensing the test fluid to the sample surface. Initial contact angles above 30 degrees are indicators of effective water and oil repellency. Contact angle can be measured after the droplet has been added to a surface (advancing contact angle, abbreviated “Adv CA”) or after the droplet has been partially withdrawn from a surface (receding contact angle, abbreviated “Rec CA”).

The result of contact angle measurements for composites 1A, 1B, 2A, 3A and 3B are summarized in Table 1.

TABLE 1
Water, hexadecane contact angles of untreated
controls and nanoweb-composites

| | Contact angle^{a} | | | |
|---|---|---|---|---|
| | Water | | Hexadecane | |
| Example | Adv CA | Rec CA | Adv CA | Rec CA |
| TYVEK ® fabric control | 108 ± 1 | 78 ± 1 | abs | abs |
| KOLON ® fabric | 115 ± 4 | 85 ± 4 | abs | abs |
| control | | | | |
| 1A | 147 ± 4 | 131 ± 3 | 66 ± 5 | 24 ± 4 |
| 1B | 157 ± 4 | 149 ± 2 | 94 ± 4 | 39 ± 4 |
| 2A | 150 ± 2 | 126 ± 1 | 74 ± 4 | 33 ± 4 |
| 3A | 146 ± 3 | 127 ± 4 | 79 ± 1 | 36 ± 3 |
| 3B | 158 ± 3 | 145 ± 2 | 96 ± 3 | 37 ± 3 |

^{a}average of 3 runs at different positions on each sample.
abs: slowly absorbed into fabric.

What we claim is:

1. A method for making a composite material comprising a porous support and a porous nanoweb comprising:
(a) providing a porous support;
(b) providing a gelling mixture comprising one or more solvents and one or more organogelators;
(c) applying the gelling mixture to the porous support;
(d) inducing said organogelators to form a nanoweb gel; and
(e) removing the one or more solvents from the nanoweb gel to provide a dry porous nanoweb coating on said porous support;
wherein the one or more solvents is a supercritical fluid.

2. The method of claim 1 wherein the supercritical fluid is supercritical carbon dioxide.

3. The method of claim 1, wherein inducing the formation of the nanoweb gel comprises one or more steps selected from the group: cooling, abating shearing, adding a non-solvent, and removing a solubilizing agent.

4. The method of claim 1, wherein removing the solvent(s) from the nanoweb gel comprises at least one step selected from: critical point drying and supercritical fluid extraction.

5. The method of claim 1, wherein said organogelator(s) form a H-bonded nanoweb gel.

6. The method of claim 1, wherein said porous support is a woven fabric, a nonwoven fabric, a porous polymer film, a porous inorganic material, wood, a wood laminate or combination of two or more thereof.

7. The method of claim 6, wherein said porous support is a woven fabric comprising fibers of glass, polyamides, polyesters or a combination of two or more thereof.

8. The method of claim 6, wherein said porous support is a nonwoven fabric comprising fibers of glass, paper, cellulose acetate and nitrate, polyamides, polyesters, polyolefin or a combination of two or more thereof.

9. The method of claim 1, wherein said gelling mixture is a homogeneous supercritical carbon dioxide solution.

10. The method of claim 1, wherein said (c) applying the gelling mixture comprises coating and impregnating the porous support with the gelling mixture.

11. The method of claim 1 wherein said organogelator is selected from materials of formulae (I) and (II), including isomers and mixtures of isomers thereof: 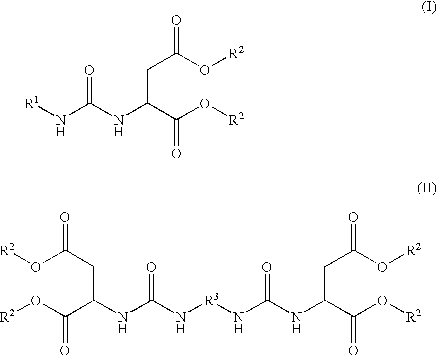
wherein
R¹ is a monovalent radical selected from C₁ to C₁₆ linear or branched alkyl group, optionally substituted with one or two carbon-carbon double bonds and optionally interrupted by one or two —OC(O)— groups; C₁ to C₆ linear or branched alkyl group bearing a C₅-C₁₆ cycloaliphatic group, optionally substituted with one or two carbon-carbon double bonds and optionally interrupted by one or two —OC(O)— groups; C₅-C₁₆ cycloaliphatic or alkyl substituted cycloaliphatic group optionally substituted with one or two carbon-carbon double bonds and optionally interrupted by one or two —OC(O)— groups; C6 to C16 aromatic or alkyl substituted aromatic group optionally substituted with one or two substituents selected from Cl, Br, I, F, CF₃, and CF₃O; C1 to C6 alkyl bearing a C6 to C16 aromatic or alkyl substituted aromatic group optionally substituted with one or two substituents selected from Cl, Br, I, F, CF₃, and CF₃O;
R² is —(CH₂)ᵤ—R_{f};
u is an integer of 1 to 4;
R_{f} is a linear or branched partially or fully fluorinated alkyl having 5 to about 20 carbon atoms, optionally interrupted by one to 6 oxygen atoms, wherein the ratio of oxygen atoms to carbon atoms is about 1:2 to about 1:10; each carbon atom having at most one oxygen atom bonded to it, and covalent bonding between oxygen atoms is absent;
R³ is a divalent radical selected from: C3 to C18 linear or branched alkylene, optionally, interrupted by one or two —OC(O)—; C1 to C6 linear or branched alkylene bearing a C5-C16 cycloaliphatic radical; C5-C16 cycloaliphatic or alkyl substituted cycloaliphatic radical; C6 to C16 aromatic or alkyl substituted aromatic radical optionally substituted with a group selected from Cl, Br, I, F, CF₃, and CF₃O; C1 to C6 alkyl bearing an C6 to C16 aromatic or alkyl substituted aromatic radical, optionally substituted with a group selected from Cl, Br, I, F, CF₃, and CF₃O; and
—(CH₂CH₂O)ₘ(CH₂CH₂)—, wherein m is an integer of 1 to 4.

12. The method of claim 11, wherein R_{f} has 6 to 20 carbon atoms and the supercritical fluid is supercritical carbon dioxide.

13. The method of claim 1 wherein said organogelator is of formula (III)
Rₒ-[L-(C_{q}H_{2q}S)ₚCᵣH₂ᵣR_{f}¹]₂ (III)
wherein
Rₒ is a divalent organic group having 2 to 40 carbon atoms;
L is a linking group selected from —NHC(O)NH— or —C(O)NH— wherein the left side of the linking group is bonded to Rₒ;
p is an integer of 0 or 1;
q is an integer of 2 to 10;
r is an integer of 1 to 10; and
R_{f}¹ is a linear or branched C₁-C₆ perfluoroalkyl group.

14. The method of claim 13 wherein L is —NHC(O)NH—.

15. The method of claim 13, wherein L is —C(O)NH—.

16. A nanoweb composite provided by the method of claim 1.

17. The nanoweb composite of claim 16 having a water droplet advancing contact angle of greater than 130°.

18. The nanoweb composite of claim 16 having a hexadecane droplet advancing contact angle of greater than 60°.
